(19) United States
(12) Patent Application Publication
(10) Pub. No.: US 2002/0093267 A1
(43) Pub. Date: Jul. 18, 2002

(54) Adjustable strength permanent magnetic rotor

(76) Inventor: Don Harris, Davenport, CA (US)

Correspondence Address: Jeffrey A. Hall, 212 Clinton Street, Santa Cruz, CA, 95062, US

(21) Appl. No.: 09/764,645

(22) Filed: Jan. 16, 2001

(51) Int. Cl. H02K 1/22

(52) U.S. Cl. 310/209; 310/195

(57) ABSTRACT

An adjustable strength permanent magnetic rotor for an alternator, comprising a pole piece assembly, and an adjustable magnetic ring assembly operably secured to the pole piece assembly. An adjustable ring retainer is operably secured to the adjustable magnetic ring assembly and a plurality of magnets are operably positioned adjacent to the pole piece assembly. A return path ring is secured and positioned adjacent to the plurality of magnets.

### BACKGROUND OF THE INVENTION

1. Field of Invention

This invention relates to rotors for alternators, and in particular to adjustable strength magnetic rotors for such alternators.

2. Description of the Related Art

Heretofore a wide variety of alternators and rotors for such alternators have been proposed and developed. Such alternators have typically used either wound electromagnetic fields or fixed strength permanent magnet fields. Wound fields have approximately a 3% to 5% loss in efficiency from electricity used to run the coil, as well as brush maintenance and coil failure problems.

Fixed permanent magnetic fields are efficient at one flux density only and cannot be changed. In many applications, such as some hydroelectric generators, the load requirements change as well as the corresponding field flux density requirements, which leads to inefficiencies.

Prior attempts at variable strength permanent magnetic rotors have included iron shunting the magnets or using a pancake-type generator with a disk rotor where the air gap is varied to control field strength. Where iron shunting is used, significant limitations arise due to low flux density because not enough iron surface is available for significant magnetic induction and the requirement for multiple air gaps. With air gap variation, low efficiencies result when a large air gap is used because of flux leakage into unwanted conductors resulting in high eddy current losses.

Accordingly, it is the primary object of this invention to provide an adjustable strength permanent magnetic rotor which is efficient, practical, and cost effective at all flux densities because the flux path remains totally or partially within the rotor at all flux levels except fully magnetic, so as not to allow eddy current losses in the stator or other conductors. It is a further object to provide a pole piece which can be easily shaped to optimize the wave form output of the alternator.

Other objects and advantages include the ability to adjust the rotor by rotating one ring of magnets with respect to the iron pole piece and another magnetic ring, that is, a rotation of one pole piece will change flux density from full to null. As the rotor pole piece interacts with the stator, the rotor pole piece can be made of low eddy current materials, and can be laminated, thereby increasing efficiency. Further, as a stationary magnetic control circuit allows the flux density in the rotor to be adjusted while the alternator is operating, this allows peak power point tracking and more convenient and efficient operation.

Additional objects and advantages of the invention will be set forth in the description which follows, and in part will be obvious from the description, or may be learned by practice of the invention. The objects and advantages of the invention may be realized and obtained by means of the instrumentality's and combinations particularly pointed out in the appended claims

### BRIEF SUMMARY OF THE INVENTION

The present invention is an adjustable strength permanent magnetic rotor for an alternator or other applications, comprising a pole piece assembly, and an adjustable magnetic ring assembly operably secured to the pole piece assembly. An adjustable ring retainer is operably secured to the adjustable magnetic ring assembly and a plurality of magnets are operably positioned adjacent to the pole piece assembly. A return path ring is secured and positioned adjacent to the plurality of magnets. In another embodiment a rotating columator and a stationary columator are included for providing a rotor with a stationary control circuit.

### BRIEF DESCRIPTION OF THE DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 is an exploded view of an adjustable strength permanent magnetic rotor, according to the invention.

FIG. 2 shows the pole piece assembly, according to the invention.

FIG. 3 shows the metallic pole pieces and supporting non-magnetic filler, according to the invention.

FIG. 4 shows a top view the adjustable magnetic ring assembly according to the invention.

FIG. 5 shows a side view of the adjustable magnetic ring assembly, according to the invention.

FIG. 6 shows the adjustable ring retainer, according to the invention.

FIG. 7 shows the rotor assembly, according to the invention.

FIG. 8 shows the return path metallic ring and adjustable ring retainer assembly, according to the invention.

FIG. 9 shows another embodiment of such rotor with a stationary control circuit, according to the invention.

### DETAILED DESCRIPTION OF THE INVENTION

Reference will now be made in detail to the present preferred embodiments of the invention as illustrated in the accompanying drawings.

In accordance with the present invention, there is provided an adjustable strength permanent magnetic rotor, comprising, a pole piece assembly, and an adjustable magnetic ring assembly operably secured to the pole piece assembly. An adjustable ring retainer is operably secured to the adjustable magnetic ring assembly and a plurality of magnets are operably positioned adjacent to the pole piece assembly. A return path ring is secured and positioned adjacent to the plurality of magnets.

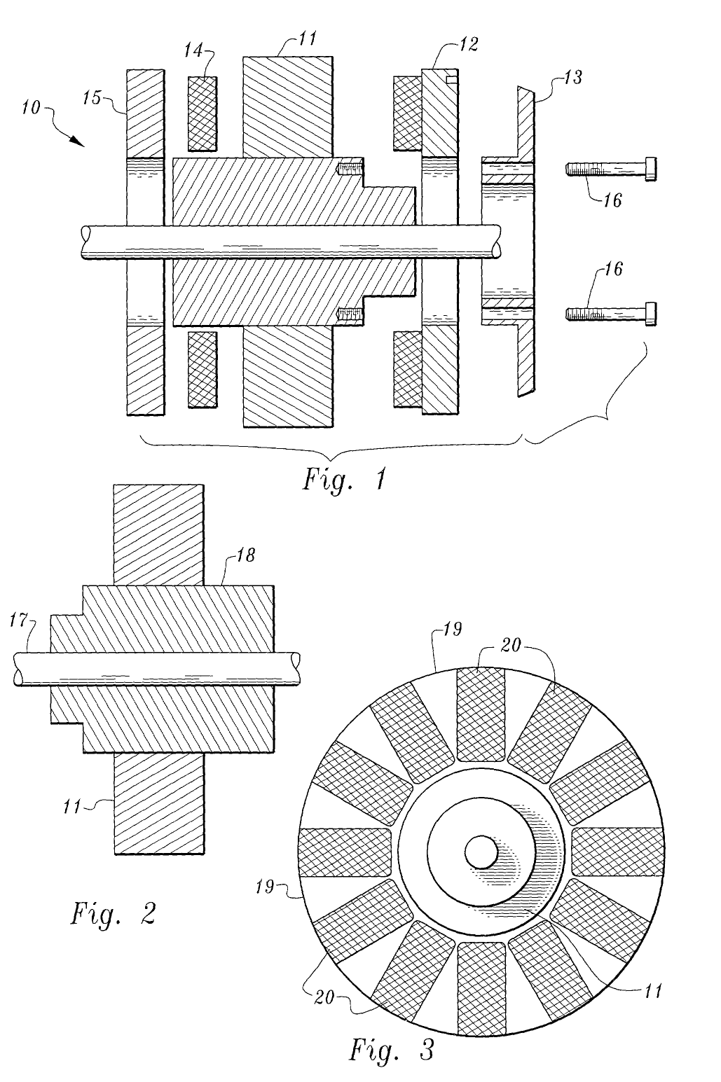

In FIG. 1, adjustable strength permanent magnetic rotor 10, is shown according to a preferred embodiment of the invention. Preferably, rotor 10 includes a pole piece assembly 11, and an adjustable magnetic ring assembly 12 operably linked thereto. An adjustable ring retainer 13 is secured to adjustable magnetic ring assembly 12, and may be secured by fastening means such as bolts 16, screws, rivets, or the like. A plurality of magnets 14, preferably 12, but may be otherwise, are operably positioned in proximity to pole piece assembly 11. A return path metallic ring 15, preferably composed of iron, is operably attached to plurality of magnets 14, so as to provide a return flux path and retain flux lines within rotor 10.

With reference to FIG. 2, preferably pole piece assembly 11 comprises a main shaft 17, secured to an aluminum substrate 18, to which pole pieces 20, are attached. A supporting filler 19, of non-magnetic material and non-electrically conductive material, such as plastic, is preferentially used.

In FIG. 3, metallic pole pieces 20, preferably composed of iron are shown with filler 19. In the embodiment shown, 12 pole pieces are used, however, in alternative embodiments rotor 10 can be constructed with any even number of pole pieces from 2 to 14 and operate efficiently. The actual pole piece active face geometry will vary depending on the stator geometry and can be shaped to optimize the output wave form of the alternator in which it is used. Pole pieces 20, may also be laminated to further reduce eddy current losses in rotor 10.

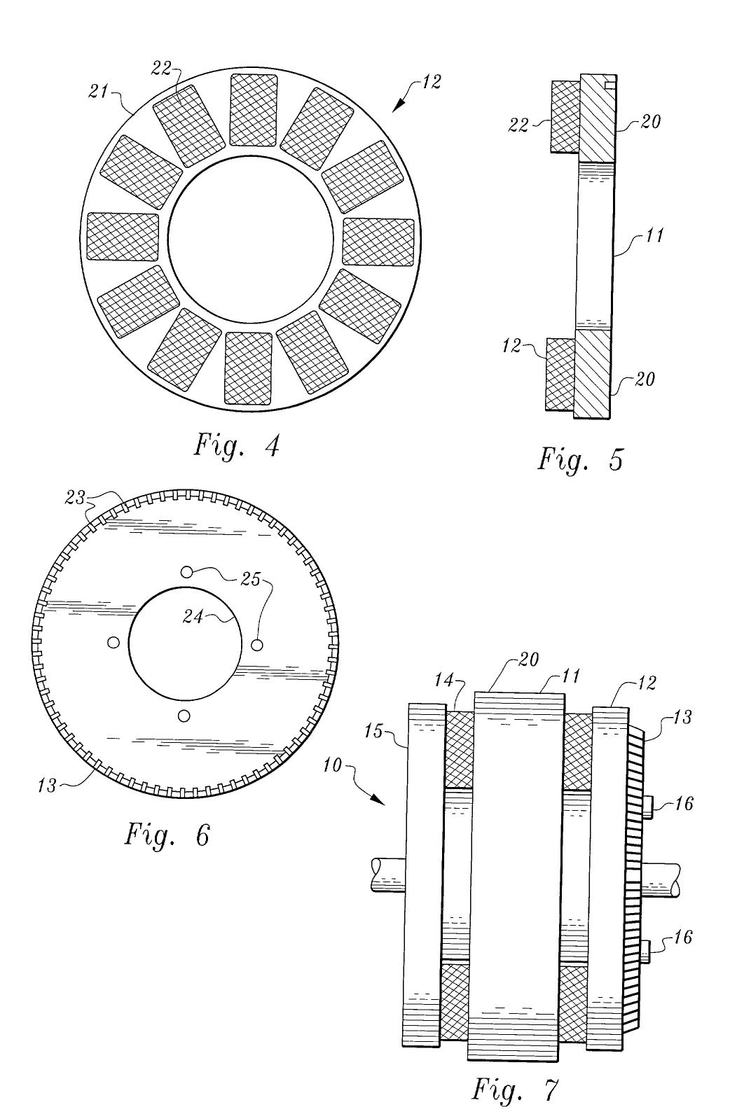

Referring now to FIG. 4, adjustable magnetic ring assembly 12 is shown. Adjustable magnetic ring assembly 12, preferably comprises a metallic, preferably iron, return path ring 21, to which an even number of magnets 22 are attached. Preferably magnets 22 are of boron, iron, neodenium magnets, but may be otherwise. As is illustrated in FIG. 4, 12 magnets are shown, however, other even numbers may also be used. Alternate North and South Pole's of magnets 22, are exposed, and are preferably positioned so as to interface with the side of iron pole pieces 20. The net flux density of rotor 10, is controlled by rotating the adjustable magnetic ring assembly with respect to pole piece assembly 11 and to magnets 14, on the other side of pole piece assembly 11. When two North or South Pole magnet faces are on an iron pole piece, flux density is maximal. When North and South Pole magnet faces are squarely on a pole piece, the flux density is null. When the adjustable magnetic ring 12 is somewhere in-between these two positions, the flux density is likewise correspondingly reduced. In FIG. 5, magnets 22, are shown positioned in operably proximity to iron pole pieces 20 of pole piece assembly 11.

With reference now to FIG. 6, adjustable ring retainer 13, is shown. As seen in FIG. 1, adjustable ring retainer assembly 13, is attached directly to pole pieces assembly 11, and when tightened, clamps the adjustably magnetic ring assembly 12, to pole piece assembly 11. When loosened, for example, with a chuck key by insertion into magnetic ring assembly 12, and then may be twisted against teeth 23 in adjustable ring retainer 13, so as to change flux density. Aperture 24 and fastener apertures 25 are also seen in FIG. 6.

In FIG. 7, a plurality of magnets 14 are shown secured to iron pole pieces 20, of pole piece assembly 11. Preferably magnets 14 are composed of an even number of boron, iron neodinieum magnets, for example 12, but may be otherwise. Magnets 14 are positioned so that alternate North and South Poles of each magnet are secured to iron pole pieces 20. Magnets 14 provide the basic flux density of rotor 10, to which is added or subtracted the flux density of adjustable magnetic ring assembly 12.

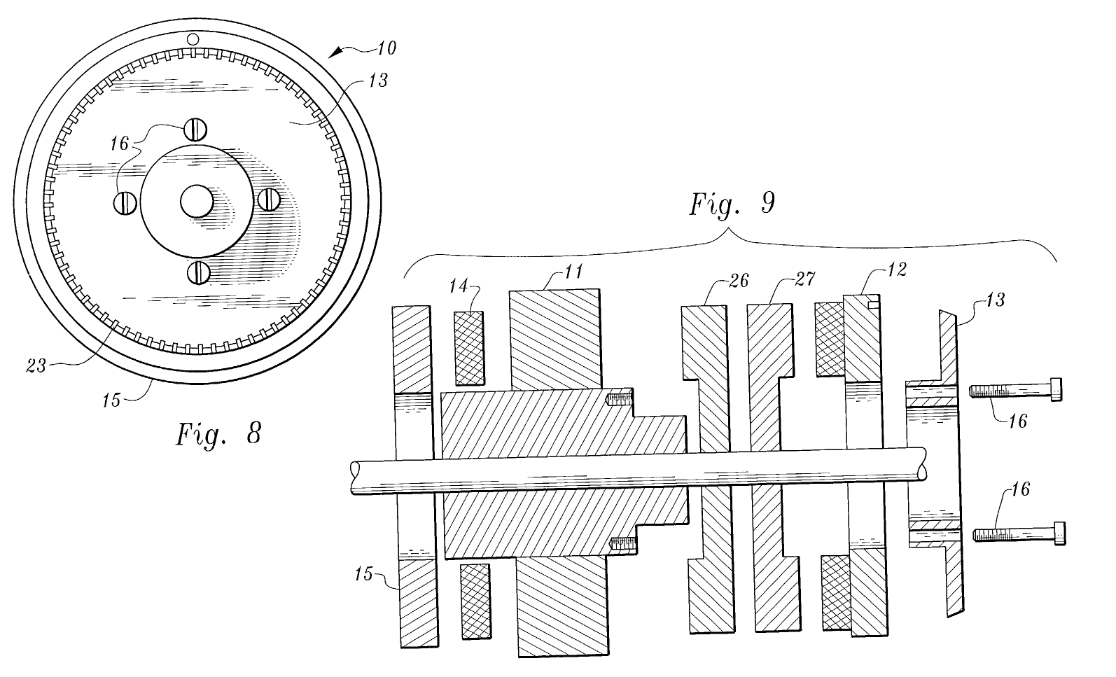

With reference now to FIG. 8, return path ring 15 is shown secured in operably proximity to magnets 14, so as to provide a return flux path and keep the flux lines within rotor 10.

In FIG. 9, an alternative embodiment of rotor 10 is shown where stationary control means are provided by a rotating columator 26 and a stationary columator 27. Preferably, in this embodiment of the invention, pole piece assembly 11 is secured to the rotating columator 26. The plurality of magnets 14, are secured to pole piece assembly 11, and to return path iron ring 15, as previously described. In this embodiment, a rotating columator 26 is preferably attached directly to pole piece assembly 11, and a stationary columator 27, is operably positioned adjacent to rotating columator 26. The adjustable magnetic ring assembly and adjustable ring retainer are attached to stationary columator 27, is the same way as they are to the pole piece assembly in a conventional rotor. The embodiment provides a regulatable permanent magnetic rotor with stationary control means.

In operation and use adjustable strength permanent magnetic rotor 10 is highly efficient at all flux densities and is easily adjusted by simply rotating the magnetic ring with respect to the iron pole pieces 20, either by mechanical, magnetic, or electronic means. Further, as rotor 10 is configured with pole piece assembly 11, which interacts with the stator, rotor 10 may be made of low eddy current materials and can be laminated, thereby increasing alternator efficiency.

As is evident from the above description, a wide variety of rotors may be configured for may different applications which utilize the adjustable strength permanent magnetic rotor described herein and additional advantages and modifications will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept

What is claimed is:

1. An adjustable strength permanent magnetic rotor for an alternator, comprising:
a pole piece assembly;
an adjustable magnetic ring assembly operably secured to said pole piece assembly;
an adjustable ring retainer, said adjustable ring retainer being operably secured to said adjustable magnetic ring assembly;
a plurality of magnets, said plurality of magnets being operably positioned adjacent to said pole piece assembly; and
a return path ring, said return path iron ring being operably positioned adjacent to said plurality of magnets.

2. The adjustable strength permanent magnetic rotor of claim 1, wherein said pole piece assembly includes an iron pole.

3. The adjustable strength permanent magnetic rotor of claim 1, wherein said adjustable magnetic ring assembly includes a plurality of magnets operably secured to an iron ring.

4. The adjustable strength permanent magnetic rotor of claim 1, wherein said plurality of magnets are secured in a ring shaped configuration.

5. The adjustable strength permanent magnetic rotor of claim 1, wherein said return path ring is composed of iron.

6. A magnetic rotor, comprising:
a pole piece assembly;
an adjustable magnetic ring assembly operably secured adjacent to said pole piece assembly;
ring retainer means, said ring retainer means being operably secured to said adjustable magnetic ring assembly;
a plurality of magnets, said plurality of magnets being operably secured said pole piece assembly; and
a return path ring, said return path ring being operably secured to said plurality of magnets.

7. The magnetic rotor of claim 6, wherein said pole piece assembly includes an iron pole.

8. The magnetic rotor of claim 6, wherein said adjustable magnetic ring assembly includes a plurality of magnets operably secured to an iron ring.

9. The magnetic rotor of claim 6, wherein said plurality of magnets are secured in a ring shaped configuration.

10. The magnetic rotor of claim 6, wherein said return path ring is composed of iron.

11. An rotor for an alternator with a stationary control circuit, comprising:
a pole piece assembly;
an adjustable magnetic ring assembly operably secured to said stationary columator;
an adjustable ring retainer, said adjustable ring retainer being operably secured to said adjustable magnetic ring assembly;
a plurality of magnets, said plurality of magnets being operably positioned adjacent to said pole piece assembly;
a return path ring, said return path iron ring being operably positioned adjacent to said plurality of magnets;
a rotating columator, said rotating columator being attached to said pole piece assembly; and
a stationary columator, said stationary columator being positioned adjacent to said rotating columator.
